(19) United States
(12) Patent Application Publication
(10) Pub. No.: US 2008/0155269 A1
(43) Pub. Date: Jun. 26, 2008

(54) Biometric authentication system and method thereof and user identification information product

(75) Inventor: Takashi Yoshikawa, Saitama (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/984,583

(22) Filed: Nov. 20, 2007

(30) Foreign Application Priority Data
Dec. 21, 2006 (JP) 2006-344792

(51) Int. Cl. H04L 9/32; H04L 9/30

(52) U.S. Cl. 713/186; 380/44

(57) ABSTRACT

The biometric authentication system of this invention includes user identification information product and authentication side system. The user identification information product acquires biometric information of user, encrypts the biometric information acquired using encryption key information provided by the authentication side system and provides encrypted biometric information to the authentication side system. Just after, the acquired biometric information is cleared up. The authentication side system stores reference encrypted biometric information and inherent encryption key when this reference encrypted biometric information is acquired, corresponding to the user identification information. At the time of authentication, encryption key information is created using at least the stored inherent encryption key and provided to the user identification information product, and then, an authentication result is formed by using the received encrypted biometric information and reference encrypted biometric information.

### CROSS REFERENCE TO RELATED APPLICATION

The disclosure of Japanese Patent Application No. JP 2006-344792 filed on Dec. 21, 2006 is incorporated herein by reference in its entirety.

### BACKGROUND OF THE INVENTION

1. Field of the Invention

The present invention relates to a biometric authentication system and method thereof and user identification information product, which may be applied to for example, automatic transaction system of banking institution.

2. Description of the Related Art

Currently, the biometric authentication method has been introduced into diversified fields such as ATM of banking institution (see Patent Document 1 and Non-Patent Document 1). According to a method used in the ATM, the ATM is equipped with a biometric information reading device, which verifies biometric information acquired by a biometric information reading device with original biometric information registered preliminarily.

### Patent Document 1: Japanese Patent Application Laid-Open No. 2002-83298

### Non-Patent Document 1: “Security Biometric Technology; Realizing High Security with Updated Biometrics, Venous Authentication system of Palm”, Video information industrial, pp. 45-48, complied by FUJITSU and FUJITSU FRONTECH LIMITED, March, 2005

However, in a conventional method, man or woman needs to bring part of his or her body into contact with or set in front of the biometric information reading device. Thus, user feels a fear that his or her biometric information may be stolen and feels a discomfort due to contact with the biometric information reading device which a number of people use in common and therefore, this is not a method which can be accepted easily. For example, in the banking institution, a very few people use the biometric authentication method.

Further, the biometric information has a problem that it becomes invalid if it is stolen even once. Another problem is that a person whose biometric information is stolen cannot receive any such service. Although a password can be changed from a stolen password, if such biometric information as information of right hand palm is stolen, a person whose biometric information is stolen cannot use any biometric authentication system which uses information of the right hand palm.

Further, to prevent forgery of an ID card, a method in which an IC is loaded on an ID card and biometric information is incorporated therein has been proposed recently. However, still if the ID card is stolen, it comes that its biometric information is stolen.

Some systems using a portable terminal instead of the ID card have been proposed recently and such a portable terminal carries out near-distance wireless communication with a device such as ATM. Such wireless communication produces a high fear that information contained therein can be stolen.

### SUMMARY OF THE INVENTION

The present invention has been achieved in views of the above-described problems and intends to provide a biometric authentication system and method which allows user to apply the biometric authentication method in a more natural way and a user identification information product which can achieve such an object.

According to a first aspect of the present invention, there is provided a user identification information product for providing user identification information to an authentication side system, including: (1) biometric information acquiring means for acquiring biometric information of user; (2) biometric information providing means for providing the acquired biometric information to the authentication side system; and (3) biometric information non-storing means for just after providing the biometric information to the authentication side system, clearing up the acquired biometric information.

According to a second aspect of the present invention, there is provided a biometric authentication system having user identification information product for providing user identification information to the authentication side system and the authentication side system which executes authentication, wherein (1) the user identification information product includes: (1-1) biometric information acquiring means for acquiring biometric information of user; (1-2) biometric information providing means for encrypting the acquired biometric information and providing to the authentication side system using encryption key information provided from the authentication side system; and (1-3) biometric information non-storing means for clearing up the acquired biometric information just after the encrypted biometric information is provided to the authentication side system, and (2) the authentication side system includes: (2-1) reference information storing means for storing at least encrypted biometric information which serves as a reference and inherent encryption key when the reference encrypted biometric information is obtained, corresponding to user identification information; (2-2) encryption key information sending means for creating the encryption key information to be provided to the user identification information product using at least the inherent encryption key stored in the reference information storing means and sending the encryption key information when user who provides the user identification information is authenticated; and (2-3) authenticating means for forming an authentication result at least from the encrypted biometric information received from the user identification information product and the reference encrypted biometric information stored in the reference information storing means.

According to a third aspect of the present invention, there is provided a biometric authentication method in which the user identification information product provides user identification information to an authentication side system and the authentication side system executes authentication, wherein (0) the user identification information product includes biometric information acquiring means, biometric information providing means and biometric information non-storing means, and the authentication side system includes reference information storing means, encryption key information sending means and authenticating means; (1) the reference information storing means of the authentication side system stores at least encrypted biometric information which serves as a reference and inherent encryption key when the reference encrypted biometric information is obtained, corresponding to user identification information; (2) the biometric information acquiring means of the user identification information product acquires biometric information of user; (3) the encryption key information sending means of the authentication side system creates the encryption key information to be provided to the user identification information product using at least the inherent encryption key stored in the reference information storing means when user who provides the user identification information is authenticated; (4) the biometric information providing means of the user identification information product encrypts the acquired biometric information using the encryption key information provided by the authentication side system and provides to the authentication side system; (5) the biometric information non-storing means of the user identification information product clears up the acquired biometric information just after the encrypted biometric information is provided to the authentication side system; and (6) the authenticating means of the authentication side system forms an authentication result from the encrypted biometric information received from the user identification information product and the encrypted biometric information stored in the reference information storing means.

The biometric authentication system, method thereof and user identification information product of the present invention enables user to apply the biometric authentication system in a more natural way.

### BRIEF DESCRIPTION OF THE DRAWINGS

FIG. 1 is a block diagram showing an entire configuration of automatic transaction system according to a first embodiment;

FIG. 2 is a sequence diagram showing a registration operation for authentication information in the first embodiment;

FIG. 3 is a sequence diagram showing authentication operation of the first embodiment;

FIG. 4 is an explanatory diagram about authentication method of the first embodiment;

FIG. 5 is a sequence diagram showing authentication operation of a second embodiment;

FIG. 6 is a sequence diagram showing authentication operation of a third embodiment; and

FIG. 7 is an explanatory diagram about the authentication method of the third embodiment.

### DETAILED DESCRIPTION OF THE PREFERRED EMBODIMENTS

Hereinafter, the preferred embodiments of the present invention will be described in detail with reference to the accompanying drawings. In the meantime, like reference numerals are attached to components having substantially like functional configuration in this specification and drawings, and repeated description thereof will not be described.

### (A) First Embodiment

The first embodiment in which the biometric authentication system, method thereof and user identification information product of the present invention are applied to automatic transaction system of banking institution will be described in detail with reference to the drawings.

### (A-1) Configuration of the First Embodiment

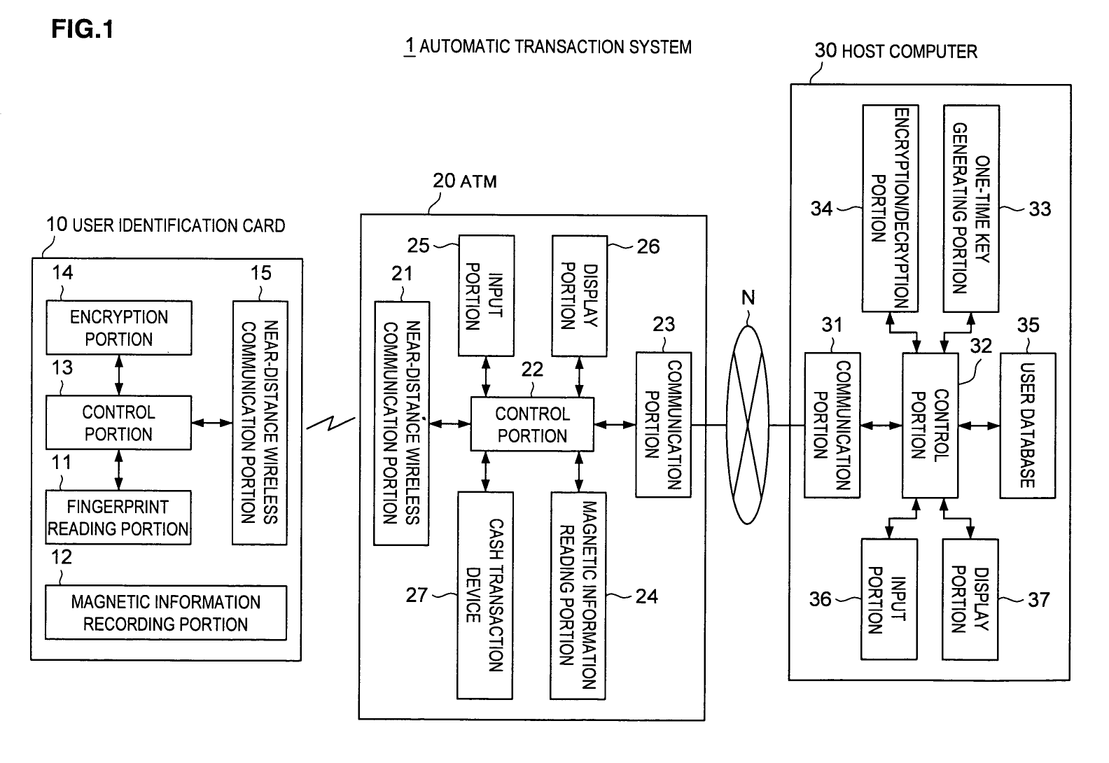

FIG. 1 is a block diagram showing the entire configuration of automatic transaction system according to the first embodiment of the invention.

Referring to FIG. 1, the automatic transaction system 1 of the first embodiment includes user identification card 10, ATM 20 and host computer 30.

The user identification card 10 corresponds to conventional ID card, including a fingerprint reading portion 11, magnetic information recording portion 12, control portion 13, encryption portion 14 and near-distance wireless communication portion 15.

In the first embodiment, the ATM 20 bears a function of relaying information in standpoint of authentication, including a near-distance wireless communication portion 21, a control portion 22, a to-host communication portion 23, a magnetic information reading portion 24, an input portion 25, a display portion 26 and a cash transaction device 27.

In the first embodiment, the host computer 30 is a main body which executes authentication, including a to-ATM communication portion 31, a control portion 32, a one-time key generating portion 33, an encryption/decryption portion 34, a user database 35, an input portion 36 and a display portion 37.

Although not shown, the user identification card 10, the ATM 20 and the host computer 30 have other components such as a power supply portion. Although the user identification card 10 is provided with an input portion for trigger operation or personal identification number input of the user identification card 10, representation thereof will not be described.

The fingerprint reading portion 11 of the user identification card 10 is for obtaining fingerprint information by reading a specific fingerprint of user. Although hereinafter, a case where read information is used as fingerprint information as it is will be described, information which picks up a characteristic amount of the read information may be used as the fingerprint information. Although in the first embodiment, the fingerprint information is used as biometric information, the type of the biometric information is not restricted to fingerprint information but any biometric information may be used as long as it can be acquired as information on the user identification card 10. For example, venous authentication, iris authentication, face authentication or vocal band authentication may be used.

Just as in recent years, a thin portable phone includes a digital camera, the user identification card 10 can carry a configuration capable of taking picture of an image if it has some extent of thickness, so that the fingerprint reading portion 11 can be achieved on the user identification card 10.

The feature of the first embodiment exists in that the user identification card 10 which user carries is equipped with the fingerprint reading portion 11.

The magnetic information recording portion 12 records user information which allows a corresponding record in the user database 35 described later to be retrieved, such as card identification information and account information, as magnetic information, for example, magnetic stripe falls under it. In the meantime, magnetic information recorded in the magnetic information recording portion 12 is read out by the magnetic information reading portion 24 of the ATM 20.

The user information is not magnetic information and may be recorded in the user identification card 10 in other style such as one-dimensional or two-dimensional bar code information and all or part of the user information may be inputted through the input portion 25 of the ATM 20.

The control portion 13 controls the user identification card 10 entirely and mainly executes encrypted transmission control of the fingerprint information. A control content of the control portion 13 will be described later clearly in a section for explanation of the operation.

The encryption portion 14 encrypts the fingerprint information obtained by the fingerprint reading portion 11 under a control of the control portion 13. According to the first embodiment, the user identification card 10 does not hold any encryption key necessary for encryption and all the encryption keys are provided by the host computer 30. The encryption portion 14 has a buffer for storing information temporarily for encryption and just after encrypted fingerprint information is outputted, the buffer is cleared.

The near-distance wireless communication portion 15 executes near-distance wireless communication with the near-distance wireless communication portion 21 of the ATM 20 under a control of the control portion 13. As the near-distance wireless communication method, any existing method such as ZigBee (registered trademark), Bluetooth (registered trademark), IrDA and the like may be adopted. Communication between the user identification card 10 and the ATM 20 may be performed through a communication channel connected directly to a connector or may be performed through a communication channel connected to a connector via a cable. Further, the communication may be performed with a communication network existing between the user identification card 10 and the ATM 20.

The near-distance wireless communication portion 21 of the ATM 20 executes near-distance wireless communication with the near-distance wireless communication portion 15 in the user identification card 10 under a control of the control portion 22.

The control portion 22 is for controlling the entire ATM 20 and regarding authentication, controls a relay for transfer of user information from the user identification card 10 to the host computer 30, transfer of encryption key from the host computer 30 to the user identification card 10 and transfer of encrypted fingerprint information from the user identification card 10 to the host computer 30.

The to-host communication portion 23 executes communication with the host computer 30 through communication network N under a control of the control portion 22.

The magnetic information reading portion 24 reads user information recorded in the magnetic information recording portion 12 of the user identification card 10 and provides to the control portion 22.

The input portion 25 and the display portion 26 constitute a man-machine interface portion, which displays a message indicating an operating guidance system or system status under a control of the control portion 22 and inputs information desired by user as required. The input portion 25 and the display portion 26 are constituted of, for example, a touch panel. For example, in standby status of the ATM 20, a transaction type list is displayed on the display portion 26 to instruct a transaction type desired by user (for example, cash withdrawal) to the input portion 25.

The cash transaction device 27 takes in and out cash under a control of the control portion 22.

The to-ATM communication portion 31 in the host computer 30 executes communication with the ATM 20 through a communication network N under a control of the control portion 32.

The control portion 32 controls the entire ATM 20 and regarding authentication, transfers an encryption key to the user identification card 10, controls decoding of the encrypted fingerprint information and verifies the information. A content of the control by the control portion 32 will be made evident in a section about description of the operation described later.

The one-time key generating portion 33 incorporates, for example, a random number generator, and generates a one-time encryption key necessary each time when fingerprint information is acquired from the user identification card 10 using the generated random number.

The encryption/decryption portion 34 decrypts or encrypts encrypted fingerprint information provided by the user identification card 10 or encrypted fingerprint information stored in the user database 35 under a control of the control portion 32. The encryption key or decryption key for use in decryption or encryption is provided by the control portion 32 each time. The encryption/decryption portion 34 converts encrypted fingerprint information provided from the user identification card 10 or encrypted fingerprint information stored in the user database 35 to information for use in verification.

The user database 35 is a database which stores information of each user, which stores at least user information, inherent encryption key and encrypted fingerprint information which serves as a reference for authentication and further stores the one-time encryption key temporarily.

The input portion 36 and the display portion 37 are for man-machine interface with a maintenance person or an administrator of the host computer 30.

### (A-2) Operation of the First Embodiment

Next, the operation of the automatic transaction system 1 of the first embodiment, particularly the operation about authentication of user will be described. Hereinafter, registration operation and authentication operation of authentication information will be described in order.

### (A-2-1) Registration Operation of Authentication Information

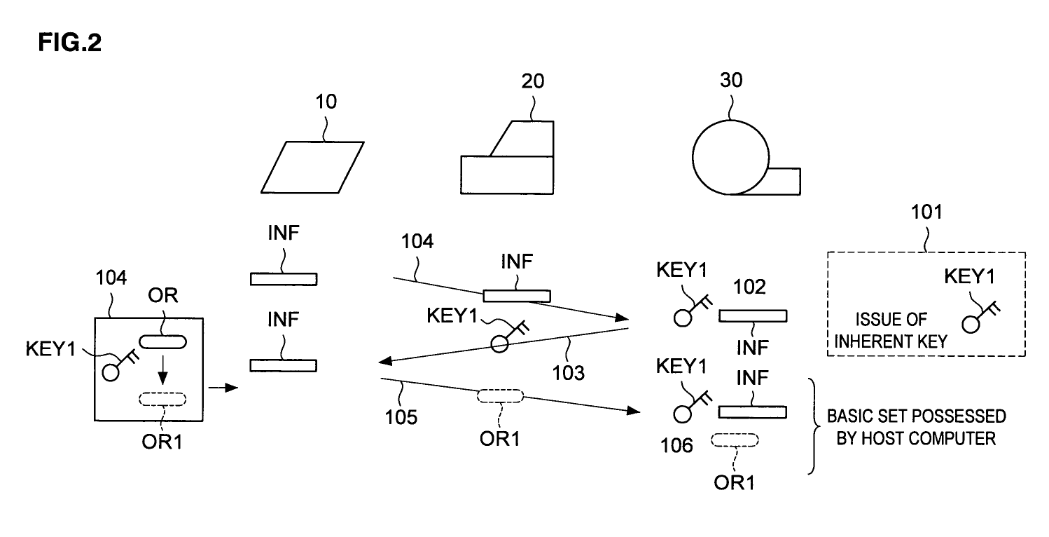

First, an operation of registering information necessary for authentication in the user database 35 of the host computer 30 will be described with reference to a sequence diagram of FIG. 2.

Although registration may be carried out by way of a device operated by a teller having the fingerprint reading portion or may be carried out by operation to the host computer 30, it will be described assuming that it is executed by way of the ATM 20 using the user identification card 10 and the fingerprint reading portion 11.

When user operates an icon on a standby screen displayed on the display portion 26 of the ATM 20 appropriately and instructs starting of the registration operation of authentication information, the control portion 22 of the ATM 20 requests user to make the ATM 20 read user information (magnetic information) of the magnetic information recording portion 12 of the user identification card 10 through the display portion 26 and then, when user performs reading operation (scanning magnetic stripe), user information INF obtained by the magnetic information reading portion 24 is given to the control portion 22 and the control portion 22 sends the user information INF together with information indicating registration mode to the host computer 30 (step 100). In the meantime, the user information to be sent may be information inputted from the input portion 25 instead of user information in the magnetic information recording portion 12 or user information in the magnetic information recording portion 12.

The control portion 32 of the host computer 30 supplied with information indicating the registration mode and user information INF stores user information INF and encryption key KEY1 in the user database 35 after the inherent encryption key KEY1 is generated by using all or part of arriving user information INF (step 101: for example, information is converted by applying a predetermined function) (step 102).

In case where a record about user (user information INF) is already provided in the user database 35 before the registration operation, generated encryption key KEY 1 is added to the record and in case where no record is provided in the user database 35 before the registration operation, in step 102, user information INF and encryption key KEY1 are stored after the record is generated.

Here, it is preferable that the encryption key KEY1 does not contain a decryption key for returning encryption information obtained by encrypting certain information with the encryption key KEY1 to its original state information. For example, if the encryption key KEY1 is expressed with a mathematical matrix, it is preferable that the encryption key KEY1 does not contain any inverse matrix.

The control portion 32 sends the generated encryption key KEY1 to the user identification card 10 through the ATM 20 (step 103). The control portion 22 of the ATM 20 requests the fingerprint of a specified finger of user to be read through the display portion 26 when this encryption key KEY1 is relayed and requests the control portion 13 of the user identification card 10 to send back information (encrypted fingerprint information) OR1 encrypted with the encryption key KEY1 which sent the obtained fingerprint information OR.

The control portion 13 of the user identification card 10 provides the received encryption key KEY1 and fingerprint information OR read by the fingerprint reading portion 11 to the encryption portion 14 and encrypts (step 104) and the encrypted fingerprint information OR1 provided from the encryption portion 14 is returned to the host computer 30 through the ATM 20 (step 105).

In the meantime, even if the fingerprint information OR or OR1 is buffered in the buffer at the time of encryption, the control portion 13 clears the buffered fingerprint information OR or OR1 when the encrypted fingerprint information OR1 is sent. In other words, after the encrypted fingerprint information OR1 is sent, the user identification card 10 possesses only the user information in the magnetic information recording portion 12.

The control portion 32 of the host computer 30 adds (registers) the returned encrypted fingerprint information OR1 to a corresponding record in the user database 35 (step 106). As information for authentication, group information of user information INF, inherent encryption key KEY1 and encrypted fingerprint information OR1 are registered in the record of the user database 35.

Although not shown in FIG. 2, after the encrypted fingerprint information OR1 is registered in the user database 35, the control portion 32 notifies the ATM 20 and the user identification card 10 of termination of the registration and terminates the registration mode.

### (A-2-2) Authentication Operation

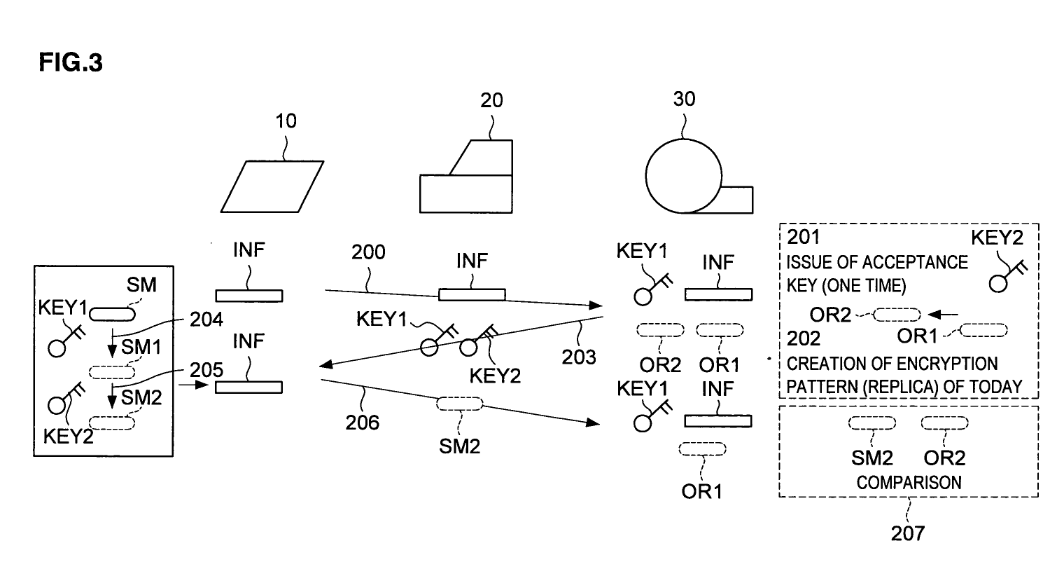

Next, the authentication operation of the automatic transaction system 1 according to the first embodiment will be described with reference to a sequence diagram of FIG. 3.

When user instructs a desired transaction type by operating an icon on the standby screen displayed on the display portion 26 of the ATM 20 appropriately, the control portion 22 of the ATM 20 determines whether or not the instructed transaction type requires authentication by user. If authentication by user is required, the control portion 22 of the ATM 20 requires user to make the ATM 20 read user information (magnetic information) in the magnetic information recording portion 12 of the user identification card 10 through the display portion 26, and user information INF obtained by the magnetic information reading portion 24 is provided to the control portion 22 by user's reading operation (scanning the magnetic stripe), so that the control portion 22 sends that user information INF to the host computer 30 together with information indicating authentication mode (step 200).

When supplied with information indicating authentication mode and user information INF, the control portion 32 of the host computer 30 starts up the one-time key generating portion 33 to generate a one-time key (acceptance key) KEY2 (step 201) and with received user information INF as a key, the encrypted fingerprint information OR1 and one-time key KEY2 taken out from the user database 35 are provided to the encryption/decryption portion 34 and the encrypted fingerprint information OR1 is encrypted further using the one-time key KEY2 so as to form verification reference encrypted fingerprint information OR2 (step 202).

With the received user information INF as a key, the control portion 32 sends the inherent encryption key KEY1 and one-time key KEY2 taken out from the user database 35 to the user identification card 10 through the ATM 20 (step 203). Upon relaying of this inherent encryption key KEY1 and one-time key KEY2, the control portion 22 of the ATM 20 requests user to make a predetermined fingerprint read through the display portion 26 and requests the control portion 13 of the user identification card 10 to send back information encrypted successively (encrypted fingerprint information) SM2 with the inherent encryption key KEY1 which sent the obtained fingerprint information SM and the one-time key KEY2.

The control portion 13 of the user identification card 10 provides the received inherent encryption key KEY1 and one-time key KEY2 and the fingerprint information SM read by the fingerprint reading portion 11 to the encryption portion 14 and first, the fingerprint information SM is encrypted with the inherent encryption key KEY1 (step 204). The obtained encrypted fingerprint information SM1 is encrypted further using the one-time key KEY2 (step 205) and the encrypted fingerprint information SM2 provided from the encryption portion 14 is sent back to the host computer 30 through the ATM 20 (step 206).

The control portion 32 of the host computer 30 authenticates by verifying the verification reference encrypted fingerprint information OR2 obtained in step 202 with the received encrypted fingerprint information SM2 (step 207). For example, it is determined that they match with each other if a value indicating correlation between the verification reference encrypted fingerprint information OR2 and the encrypted fingerprint information SM2 is over a predetermined value. Assuming that the verification reference encrypted fingerprint information OR2 and the encrypted fingerprint information SM2 are expressed in matrix, the verification is carried out by estimation of likelihood using variance/covariance of both the information.

Although omitted in FIG. 3, an authentication result of affirmative result or negative result is sent back to the ATM 20 or the user identification card 10 and substantially simultaneously, the one-time key KEY2 is erased. The ATM 20 moves to a specific processing of a transaction type which user desires when the authentication result of the affirmative result is provided.

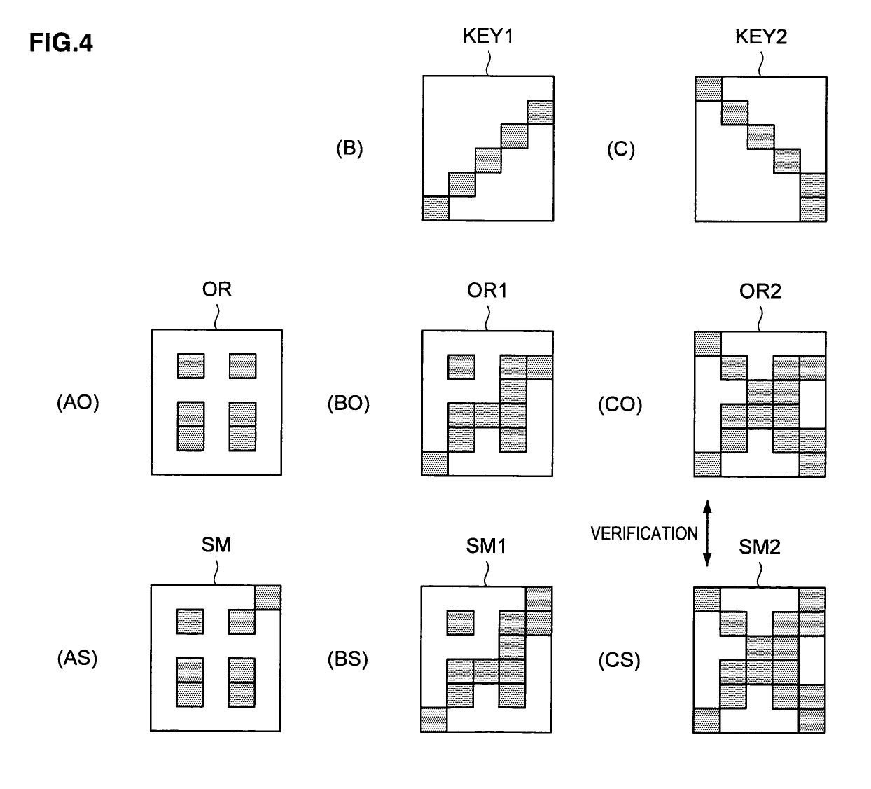

FIG. 4 is a schematic explanatory diagram of an authentication method of the first embodiment. The fingerprint information OR read at the time of registration is image information shown in FIG. 4-(AO), the fingerprint information SM read at the time of authentication is image information shown in FIG. 4-(AS), the inherent encryption key KEY1 is image information shown in FIG. 4-(B) and the one-time key KEY2 is image information shown in FIG. 4-(C).

At the time of registration, the encrypted fingerprint information OR1 shown in FIG. 4-(BO), which is an encryption (product) of the read fingerprint information OR shown in FIG. 4-(AO) by the inherent encryption key KEY1 shown in FIG. 4-(B), is stored in the user database 35.

At the time of authentication, the encrypted fingerprint information SM1 shown in FIG. 4-(BS), which is an encryption (product) of the read finger information SM shown in FIG. 4-(AS) by the inherent encryption key KEY1 shown in FIG. 4-(B) and the encrypted fingerprint information SM2 shown in FIG. 4-(CS), which is an encryption (product) thereof by the one-time key KEY2 shown in FIG. 4-(C), are sent from the user identification card 10 to the host computer 30. Further, the encrypted fingerprint information OR2 shown in FIG. 4-(CO), which is an encryption (product) of the encrypted fingerprint information OR1 shown in FIG. 4-(BO) stored in the user database 35 by the one-time key KEY2 shown in FIG. 4-(C), is formed.

The encrypted fingerprint information SM2 shown in FIG. 4-(CS) and the encrypted fingerprint information OR2 shown in FIG. 4-(CO) are verified. In this case, only one pixel in 30 pixels of 6×5 is inconsistent and consequently, an affirmative authentication result is obtained.

### (A-3) Effect of the First Embodiment

Because according to the first embodiment, the user identification card 10 carried by user is provided with a fingerprint reading portion to read the fingerprint, in other words, the fingerprint reading portion is provided on other device than a commonly used one to read the fingerprint, the authentication can be executed without user's contact with the commonly used device, so that user can be released from a feeling of insanitation or a feeling of anxiety of his or her own fingerprint being read out.

According to the first embodiment, the registered fingerprint information is a fingerprint information encrypted with the inherent encryption key and the fingerprint information itself is never transmitted or left in the user identification card 10. Thus, the fingerprint information can be prevented from being stolen. If the registration operation is carried out with a device operated by a teller and a host computer without use of the configuration of the user identification card 10, stealing of the fingerprint information can be blocked further.

Further, according to the first embodiment, the inherent encryption key is taken out from the host computer 30 with user information as a key at the time of authentication and therefore the user identification card 10 is not equipped with any encryption key. Consequently, even if the user identification card 10 is stolen, it can be prevented from being used for a wrong purpose.

Further, according to the first embodiment, the encrypted fingerprint information to be transferred from the user identification card 10 to the host computer 30 at the time of authentication is encrypted with the one-time key. Consequently, even if it is intercepted during transmission, it cannot be used for a wrong purpose after that. Likewise, even if the one-time key is intercepted when it is transferred from the host computer 30 to the user identification card 10, it cannot be used for a wrong purpose after that.

### (B) Second Embodiment

Next the second embodiment in which the biometric authentication system, method thereof and user identification information product are applied to the automatic transaction system of banking institution will be described with reference to the drawings. Hereinafter, different points from the first embodiment will be described.

The entire configuration of the automatic transaction system 1 of the second embodiment and the internal configuration of the user identification card 10, ATM 20 and host computer 30 are shown in FIG. 1 of the first embodiment.

According to the second embodiment, the one-time key generating portion 33 in the host computer 30 generates a pair of public key and secret key based on public key encryption system, different from the first embodiment. The public key encryption system has been described in, for example, http://www.softech.co.jp/mm_{—}060104_farm.htm.

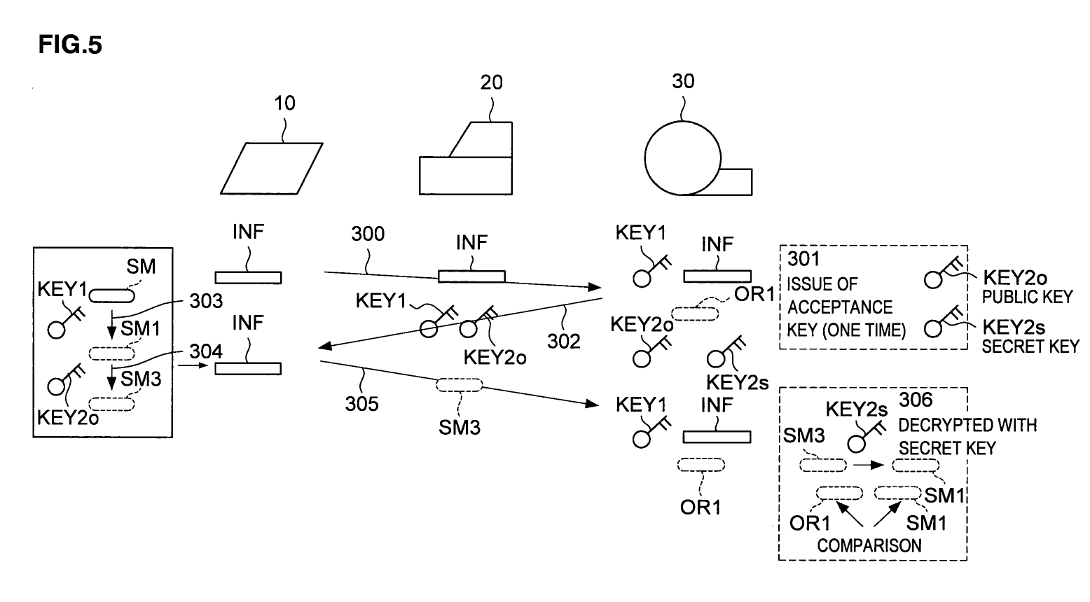

Because a pair of the public key and secret key is used as the one-time key, the authentication operation is different from the first embodiment and hereinafter, the automatic transaction system 1 of the second embodiment will be described by referring to the sequence diagram of FIG. 5. In the meantime, the registration operation of the authentication information is the same as the first embodiment.

When authentication by user is required, the control portion 22 of the ATM 20 requests user to make user information (magnetic information) in the magnetic information recording portion 12 of the user identification card 10 read into the ATM 20 through the display portion 26 and consequently, the user information INF obtained by the magnetic information reading portion 24 is provided to the control portion 22 by reading operation by user (scanning magnetic stripe) and the control portion 22 transmits the user information INF to the host computer 30 together with information indicating authentication mode (step 300).

When supplied with information indicating authentication mode and the user information INF, the control portion 32 of the host computer 30 starts up the one-time key generating portion 33 to generate a pair of public key KEY2o and secret key KEY2s as the one-time key (step 301).

The control portion 32 sends the inherent encryption key KEY1 taken out from the user database 35 with the received user information INF as a key and the generated public key KEY2o to the user identification card 10 through the ATM 20 (step 302). Upon relaying of this inherent encryption key KEY1 and the public key KEY2o, the control portion 22 of the ATM 20 requests user to make the fingerprint of a specified finger read through the display portion 26 and the control portion 13 of the user identification card 10 to send back information encrypted successively (encrypted fingerprint information) SM3 by the inherent encryption key KEY1 and the public key KEY2o which sent the obtained fingerprint information SM. In the meantime, when the control portion 32 takes out the inherent encryption key KEY1 from the user database 35, it takes out the encrypted fingerprint information OR1 also.

The control portion 13 of the user identification card 10 provides the received inherent encryption key KEY1 and public key KEY2o and the fingerprint information SM read by the fingerprint reading portion 11 to the encryption portion 14. First, the fingerprint information OR is encrypted using the inherent encryption key KEY1 (step 303) and then, the obtained encrypted fingerprint information SM1 is encrypted further using the public key KEY2o (step 304) and the encrypted fingerprint information SM3 provided from the encryption portion 14 is sent back to the host computer 30 through the ATM 20 (step 305).

The control portion 32 of the host computer 30 decrypts the received encrypted fingerprint information SM3 with the generated secret key KEY2s (step 306) and authenticates by verifying the reference encrypted fingerprint information OR1 taken out in step 302 with the encrypted fingerprint information SM1 obtained by decryption (step 307).

Because the second embodiment can exert the same effect as the first embodiment and adopts the public key encryption system, there is such an effect that the security can be intensified further.

### (C) Third Embodiment

The third embodiment in which the biometric authentication system, method thereof and the user identification information product of the present invention are applied to the automatic transaction system of banking institution will be described in detail with reference to the drawings. Hereinafter, different points from the first embodiment will be described.

In the automatic transaction system 1 of the third embodiment, its entire configuration, and the internal configuration of the user identification card 10, the ATM 20 and the host computer 30 are shown in FIG. 1 of the first embodiment.

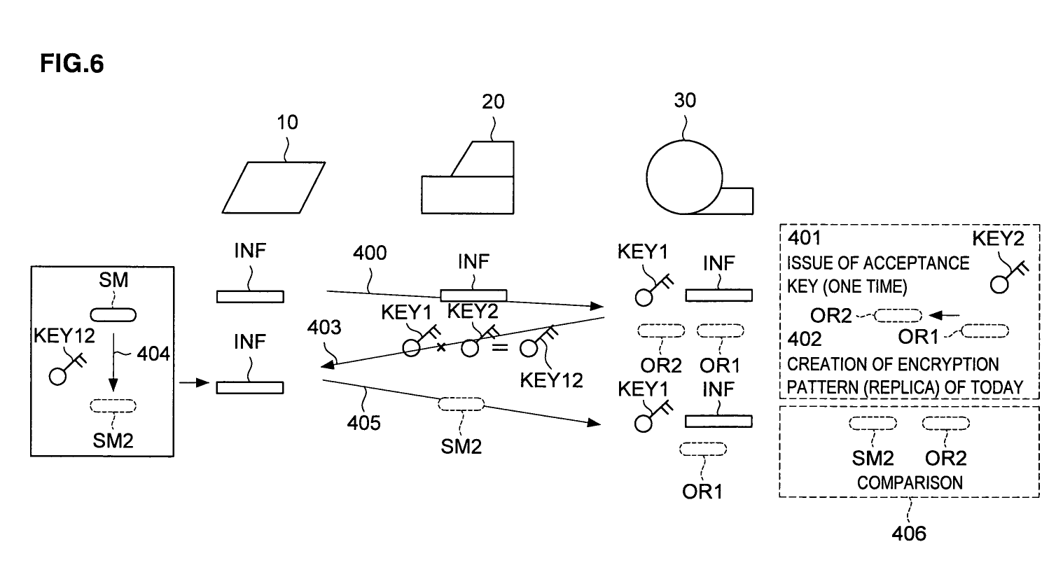

In case of the third embodiment, its authentication operation is different from that of the first embodiment and hereinafter, the authentication operation of the automatic transaction system according to the third embodiment will be described with reference to a sequence diagram of FIG. 6. In the meantime, the registration operation of authentication information is the same as the first embodiment.

When authentication by user is required, the control portion 22 of the ATM 20 requests user to make user information (magnetic information) in the magnetic information recording portion 12 of the user identification card 10 read into the ATM 20 through the display portion 26 and consequently, the user information INF obtained by the magnetic information reading portion 24 is provided to the control portion 22 by reading operation by user (scanning magnetic stripe) and the control portion 22 transmits the user information INF to the host computer 30 together with information indicating authentication mode (step 400).

When supplied with information indicating authentication mode and the user information INF, the control portion 32 of the host computer 30 starts up the one-time key generating portion 33 to generate the one-time key (acceptance key) KEY2 (step 401) and with the received user information INF as a key, the encrypted fingerprint information OR1 and one-time key KEY2 taken out from the user database 35 are provided to the encryption/decryption portion 34 to encrypt the encrypted fingerprint information OR1 further using the one-time key KEY2 to form the verification reference encrypted fingerprint information OR2 (step 402).

The control portion 32 forms a key KEY12 (for example, KEY12=KEY1×KEY2) by synthesizing the inherent encryption key KEY1 taken out from the user database 35 with the received user information INF as a key and the one-time key KEY2, using an operator which allows a combination law like four arithmetic operations to be established and sends to the user identification card 10 through the ATM 20 (step 403). Upon relaying of this synthetic key KEY12, the control portion 22 of the ATM 20 requests user to make the fingerprint of a specified finger read through the display portion 26 and further requests the control portion 13 of the user identification card 10 to send back the information (encrypted fingerprint information) SM2 encrypted with the synthetic key KEY12 which sent the obtained fingerprint information SM.

Preferably, the synthetic key KEY12 has a decryption key which returns encryption information provided by encrypting some information with the synthetic key KEY12 to its original state information. For example, if the synthetic key KEY12 is expressed with a mathematical matrix, preferably, the synthetic key KEY12 has no inverse matrix.

The control portion 13 of the user identification card 10 provides the received synthetic key KEY12 and the fingerprint information SM read by the fingerprint reading portion 11 to the encryption portion 14 to encrypt the fingerprint information OR using the synthetic key KEY12 (step 404). The encrypted fingerprint information SM2 provided from the encryption portion 14 is returned to the host computer 30 through the ATM 20 (step 405).

The control portion 32 of the host computer 30 authenticates by verifying the verification reference encrypted fingerprint information OR2 obtained in step 402 with the received encrypted fingerprint information SM2 (step 406).

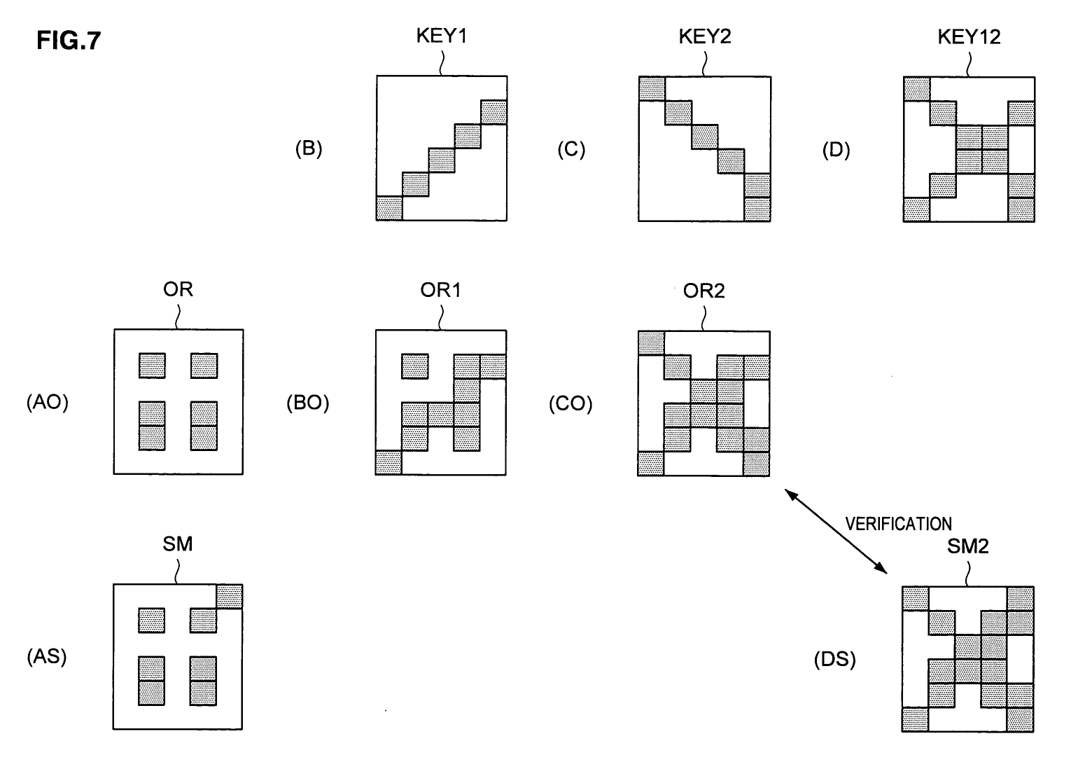

FIG. 7 is a schematic explanatory diagram of an authentication method according to the third embodiment. The fingerprint information OR read at the time of registration is image information shown in FIG. 7-(AO), the fingerprint information SM read at the time of authentication is image information shown in FIG. 7-(AS), the inherent encryption key KEY1 is image information shown in FIG. 7-(B) and the one-time key KEY2 is image information shown in FIG. 7-(C).

Like the first embodiment, the encrypted fingerprint information OR1 shown in FIG. 7-(BO), which is an encryption (product) of the read fingerprint information OR shown in FIG. 7-(AO) using the inherent encryption key KEY1 shown in FIG. 7-(B) is stored in the user database 35 at the time of registration.

At the time of authentication, the encrypted fingerprint information SM2 shown in FIG. 7-(DS), which is an encryption of the read finger information SM shown in FIG. 7-(AS) by a synthetic key KEY12, which is a synthesis of the inherent encryption key KEY1 shown in FIG. 7-(B) and the one-time key KEY2 shown in FIG. 7-(C), is sent from the user identification card 10 to the host computer 30. Further, the encrypted fingerprint information OR2 shown in FIG. 7-(CO), which is an encryption (product) of the encrypted fingerprint information OR1 shown in FIG. 7-(BO) stored in the user database 35 by the one-time key KEY2 shown in FIG. 7-(C), is formed.

The encrypted fingerprint information SM2 shown in FIG. 7-(DS) is verified with the encrypted fingerprint information OR2 shown in FIG. 7-(CO).

The third embodiment can exert the same effect as the first embodiment and further because no inherent key itself is transferred at the time of authentication, the inherent key can be prevented from being stolen thereby intensifying the security further.

When the encrypted fingerprint information OR1 is stolen, even if a stealing person acquires the synthetic key KEY12, he or she cannot form the encrypted fingerprint information OR2 or SM2 for use in verification and fails authentication.

### (D) Other Embodiment

The modifications have been mentioned in the respective embodiments above and further modifications exemplified below can be mentioned.

Although in the above respective embodiments, only authentication based on biometric information has been indicated, it is permissible to use other authentication such as use of a personal identification number and in such a case, even if the biometric information is stolen, the security can be maintained high. Further, it is permissible to use plural biometric authentications. For example, the same kind of the authentications like authentication with the thumb and authentication with the index finger may be used or it is permissible to use different kinds of authentications like authentication with the face and authentication with the vein.

Although in the above respective embodiments, an example in which no authentication is performed with the user identification card 10 has been indicated, it is permissible to provide a detecting portion for detecting a biometric state quantity capable of guaranteeing that the biometric information has been acquired at real time so as to carry out auxiliary authentication. For example, in parallel to reading of the fingerprint, it is permissible to obtain information such as body temperature and pulse rate so as to confirm a contact of the finger. The body temperature and pulse rate may be verified with a range information of the body temperature and pulse rate preliminarily registered in the user identification card 10. Consequently, it can be guaranteed that the fingerprint information has been acquired by reading at a real time. For example, any fingerprint information acquired by reading a photograph of a finger can be excluded. In the meantime, the body temperature and pulse rate may be included in transmission information.

Although in the above respective embodiments, an example that verification of information is carried out by the host computer has been indicated, the verification may be carried out by the ATM. The configuration of the system on an authentication side is not restricted to two-stage configuration of the ATM and host computer. The authentication side system may be constituted of one apparatus or server or three or more apparatuses or servers. For example, the user database may be realized on a different server from the host computer.

Although in the above respective embodiments, an example by using the one-time key has been indicated, the system may be constructed without use of the one-time key. For example, at the time of authentication, it is permissible to encrypt the fingerprint information SM by providing the inherent encryption key KEY1 to the user identification card 10 so as to encrypt the fingerprint information SM so that the host computer 30 verifies the registered encrypted fingerprint information OR1 which is encrypted each time with the encrypted fingerprint information SM1. For a system sufficient only if a feeling of insanity or a feeling of uneasiness of being read by the commonly used device can be eliminated, it is permissible to omit encryption using the inherent encryption key KEY1.

Although in the above respective embodiments, an example that the encrypted fingerprint information to be transmitted from the user identification card 10 to the host computer 30 is provided with no information about a term of validity has been indicated, an extremely short term (about 2, 3 minutes after transmission) may be transmitted. In such a case, an encrypted fingerprint information which was stolen or intercepted and actually used can be handled as invalid information. The term of validity is a sufficient term capable of guaranteeing the authentication operation of this time.

Although in the above respective embodiments, an example that the user identification information product of the present invention is the user identification card 10 has been indicated, such a portable terminal as a portable phone and electronic money terminal may be used as the user identification information product of the present invention.

Initial registration of the encrypted fingerprint information may be used using a high performance device within a bank and the like, which has been already mentioned in some places of the above description, and in such a case, the higher quality and high security information registration can be carried out.

The operations of the user identification card 10 and the host computer 30 are carried out by installing a predetermined biometric authentication program into the user identification card 10 or the host computer 30 although not mentioned in the above respective embodiments and in other words, the biometric authentication program also has the feature of the present invention.

The present invention is not restricted to the authentication in banking institutions but may be applied to various kinds of systems using biometric authentication. Because the user identification information product (user identification card 10) of the present invention may be used commonly in plural systems because no encryption key is stored. The reason is that there is no fear that the encryption key may be known to other system.

What is claimed is:

1. A user identification information product for providing user identification information to an authentication side system, comprising:
biometric information acquiring means for acquiring biometric information of user;
biometric information providing means for providing the acquired biometric information to the authentication side system; and
biometric information non-storing means which just after providing the biometric information to the authentication side system, clears up the acquired biometric information.

2. The user identification information product according to claim 1, wherein the biometric information providing means encrypts the acquired biometric information using an encryption key provided by the authentication side system and provides to the authentication side system.

3. The user identification information product according to claim 1, wherein the biometric information acquiring means further includes a detecting portion for detecting a biometric state quantity capable of guaranteeing that biometric information is acquired at a real time and the biometric information providing means provides the biometric information under a condition that the detection result of the detecting portion can guarantee.

4. The user identification information product according to claim 1, wherein the biometric information providing means provides biometric information by adding information about a term of validity determined by taking into account a time required for authentication to the biometric information to be provided to the authentication side system.

5. A biometric authentication system having user identification information product for providing user identification information to the authentication side system and the authentication side system which executes authentication, wherein
the user identification information product comprises:
biometric information acquiring means for acquiring biometric information of user;
biometric information providing means for encrypting the acquired biometric information and providing to the authentication side system using encryption key information provided from the authentication side system; and
biometric information non-storing means for clearing up the acquired biometric information just after the encrypted biometric information is provided to the authentication side system, and
the authentication side system comprises:
reference information storing means for storing at least encrypted biometric information which serves as a reference and inherent encryption key when the reference encrypted biometric information is obtained, corresponding to user identification information;
encryption key information sending means for creating the encryption key information to be provided to the user identification information product using at least the inherent encryption key stored in the reference information storing means and sending the encryption key information when user who provides the user identification information is authenticated; and
authenticating means for forming an authentication result at least from the encrypted biometric information received from the user identification information product and the reference encrypted biometric information stored in the reference information storing means.

6. The biometric authentication system according to claim 5, wherein the inherent encryption key stored in the reference information storing means is a irreversible encryption key having no decryption key corresponding thereto.

7. The biometric authentication system according to claim 5, wherein the authentication side system has a one-time key generating means for generating at least an encryption key for one time when user who provides user identification information is authenticated, and the encryption key information sending means creates the encryption key information to be provided to the user identification information product using the generated one-time encryption key and the inherent encryption key stored in the reference information storing means and sends the encryption key information.

8. The biometric authentication system according to claim 7, wherein the encryption key information sending means of the authentication side system creates the encryption key information containing two encryption keys, that is, the inherent encryption key stored in the reference information storing means and the one-time encryption key generated by the one-time key generating means and sends to the user identification information product;
the biometric information providing means of the user identification information product encrypts the biometric information acquired by the biometric information acquiring means using the inherent encryption key and further encrypts with the one-time encryption key and then provides to the authentication side system; and
the authenticating means of the authentication side system verifies the encrypted biometric information received from the user identification information product with the encrypted biometric information produced by encrypting the reference encrypted biometric information stored in the reference information storing means with the one-time encryption key so as to form an authentication result.

9. The biometric authentication system according to claim 7, wherein the one-time key generating means of the authentication side system generates a public key based on public key encryption system and a secret key;
the encryption key information sending means of the authentication side system creates the encryption key information containing two encryption keys, that is, the inherent encryption key stored in the reference information storing means and the public key generated by the one-time key generating means and sends to the user identification information product;
the biometric information providing means of the user identification information product encrypts the biometric information acquired by the biometric information acquiring means with the inherent encryption key and further encrypts with the public key and provides the encrypted biometric information to the authentication side system; and
the authenticating means of the authentication side system verifies the encrypted biometric information produced by decrypting the encrypted biometric information received from the user identification information product with the secret key with the reference encrypted biometric information stored in the reference information storing means so as to form an authentication result.

10. The biometric authentication system according to claim 7, wherein the encryption key information sending means of the authentication side system creates the encryption key information produced by synthesizing the inherent encryption key stored in the reference information storing means with the one-time encryption key generated by the one-time key generating means and sends to the user identification information product;
the biometric information providing means of the user identification information product encrypts the biometric information acquired by the biometric information acquiring means based on a product of the inherent encryption key and the one-time encryption key and provides to the authentication side system; and
the authenticating means of the authentication side system verifies the encrypted biometric information received from the user identification information product with the encrypted biometric information produced by encrypting the reference encrypted biometric information stored in the reference information storing means with the one-time encryption key.

11. The biometric authentication system according to claim 10, wherein the encryption key information is a product of the inherent encryption key and the one-time encryption key.

12. The biometric authentication system according to claim 10, wherein the encryption key information produced by synthesizing the inherent encryption key with the one-time encryption key is an irreversible encryption key having no decryption key corresponding thereto.

13. The biometric authentication system according to claim 11, wherein the encryption key information which is a product of the inherent encryption key and the one-time encryption key is an irreversible encryption key having no decryption key corresponding thereto.

14. The biometric authentication system according to claim 5, wherein the authentication side system comprises a first device for executing authentication and a second device for relaying exchange of information between the user identification information product and the first device.

15. A biometric authentication method in which the user identification information product provides user identification information to an authentication side system and the authentication side system executes authentication, wherein
the user identification information product comprises biometric information acquiring means, biometric information providing means and biometric information non-storing means, and the authentication side system comprises reference information storing means, encryption key information sending means and authenticating means;
the reference information storing means of the authentication side system stores at least encrypted biometric information which serves as a reference and inherent encryption key when the reference encrypted biometric information is obtained, corresponding to user identification information;
the biometric information acquiring means of the user identification information product acquires biometric information of user;
the encryption key information sending means of the authentication side system creates the encryption key information to be provided to the user identification information product using at least the inherent encryption key stored in the reference information storing means and sends the encryption key information when user who provides the user identification information is authenticated;
the biometric information providing means of the user identification information product encrypts the acquired biometric information using the encryption key information provided by the authentication side system and provides to the authentication side system;
the biometric information non-storing means of the user identification information product clears up the acquired biometric information just after the encrypted biometric information is provided to the authentication side system; and
the authenticating means of the authentication side system forms an authentication result from the encrypted biometric information received from the user identification information product and the encrypted biometric information stored in the reference information storing means.
